(19) United States
(12) Patent Application Publication
(10) Pub. No.: US 2004/0098173 A1
(43) Pub. Date: May 20, 2004

(54) Method for operating an electrostatic filter

(76) Inventor: Norbert Grass, Herzogenaurach (DE)

Correspondence Address: HARNESS, DICKEY & PIERCE, P.L.C., P.O.BOX 8910, RESTON, VA, 20195, US

(21) Appl. No.: 10/398,731

(22) PCT Filed: Oct. 8, 2001
(86) PCT No.: PCT/DE01/03845

(30) Foreign Application Priority Data
Oct. 9, 2000 (DE) 100 50 188.5

(51) Int. Cl. G05D 3/12

(52) U.S. Cl. 700/297

(57) ABSTRACT

A method is for operating an electrostatic filter. The real electrostatic filter is transformed to a filter model that includes at least one inlet zone, at least one center zone and at least one outlet zone. A predetermined characteristic is associated with every of the three model zones. The energy supply for a predetermined number of the model zones is controlled in accordance with the characteristic and depending on the desired value of particle emission.

The invention relates to a method for operating an electrostatic separator.

Electrostatic separators are used for removing dust from gases in a very wide range of technical processes. In this case, a number of deposition electrodes are arranged in the gas flow. Corona-discharge electrodes in the form of wires are preferably inserted between these deposition electrodes, with a high DC voltage in the order of magnitude of about 50 KV being applied between the corona-discharge electrodes, which are in each case electrically connected in parallel, on the one hand and the deposition electrodes on the other hand. In this way, the gas molecules are ionized and then emit their charge to the dust particles contained in the gas flow, which become negatively charged and are in consequence drawn to the positively charged part of the electrode. There, they can be detached by vibration or by means of stripping devices, and then fall downward into a dust collecting apparatus.

This principle allows widely differing parts of particles to be deposited from widely differing types of gas flow, although this results in highly fluctuating operating parameters for the electrostatic separator depending on the application. The burning of different types of coal results, for example, in different quantities of particles and different exhaust gas characteristics in the electrostatic separators. For example, in order to achieve the required pure gas dust content in the case of coals with low-resistance ash components and large ash contents, considerably more energy is required in the electrostatic separator than in the case of coales with a low ash component.

In the case of the electrostatic separators that are already known, reliable compliance with the limit values for particle emission are ensured only at the full power level of the high-voltage supply, which leads to a correspondingly high power consumption.

The manual adjustment of the appliances, which has also been carried out until now, requires a large amount of effort by a trained operator. Derating of the electrostatic separator, which is intrinsically possible, is also possible only to a restricted extent owing to the not inconsiderably increase in the cost of the respective industrial process associated with this. The burning of any specific types of coal leads to it not being possible to make full use of market developments.

DE 42 22 069 A1 describes a method for operating an electrostatic separator, as well as an electrostatic separator for carrying out the method. In the known case, a nominal spark gap, which builds up a further electrical high-voltage field, is operated away from the active deposition zone of the electrostatic separator, that is to say away from the electrical high-voltage field which forms this deposition zone. The nominal spark gap is operated in an area which is free of dust but is otherwise subjected to all the major operating parameters of the medium flow. This is intended on the one hand to avoid glow-discharge fires within the electrostatic separator and, on the other hand, a further aim is in consequence to keep the operating voltage of the electrostatic separator at a level where it is always as close as possible to the flash over limit.

Furthermore, a method for dust removal from flue gases is described in DE 41 40 229 A1. In this method a nominal/actual value difference is compared with process parameters that are determined experimentally in advance. The process parameters are determined experimentally in this case in a process which is optimized in terms of the dust removal level and the efficiency. The known method is intended to result in the electrostatic separators being operated as efficiently as possible, from both the ecological and economic points of view.

The object of the present invention is therefore to provide a method for operating an electrostatic separator which ensures reliable compliance with the limit values for particle emission in a simple manner.

According to the invention the object is achieved by a method as claimed in claim 1. Advantageous refinements of the method according to the invention are specified in the dependent claims.

In the method according to the invention for operating an electrostatic separator, the actual electrostatic separator is transformed to a separator model which has at least one input zone, at least one central zone and at least one output zone, with each of the at least three model zones having an associated characteristic which can be predetermined. The power supply for a number, which can be predetermined, of these model zones is regulated in accordance with this characteristic, as a function of the nominal value for the particle emission.

In the method according to the invention, peak values, such as those which frequently occur during plate knocking, are limited, thus ensuring that the predetermined limit values are reliably complied with. The transformation of the actual electrostatic separator to a separator model which has at least one input zone, at least one central zone and at lest one output zone allows the method as claimed in claim 1 to be used with any desired arrangement of electrostatic separators. Each of the three model zones in this case has a specific associated characteristic. The power supply for a number, which can be predetermined, of these model zones is regulated in accordance with this characteristic as a function of the nominal value for particle emission.

The modeling results in simplification of the algorithms and in shortening of the optimization duration for the relevant electrostatic separator.

Exemplary embodiments of the invention will be explained in more detail in the following text with reference to the drawing, in which:

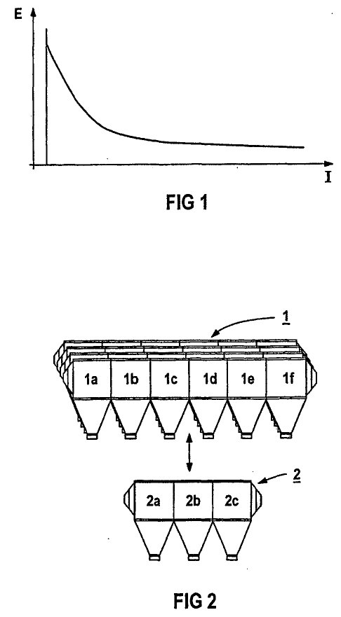

FIG. 1 shows a diagram of the particle emission plotted against the electrical current supplied to the electrostatic separator,

FIG. 2 shows an illustration in the form of a graph of the transformation of a actual multistage electrostatic separator to a separator model,

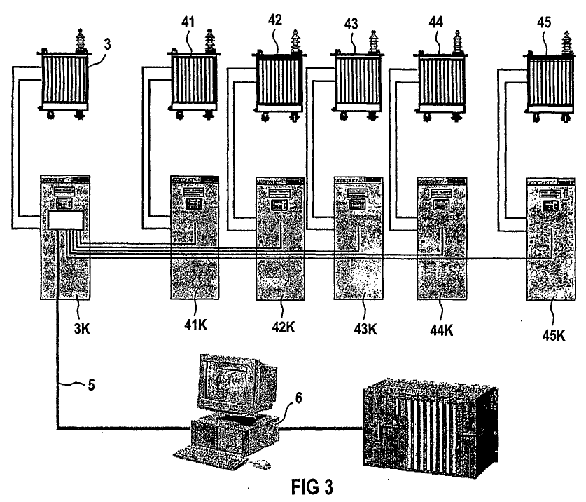

FIG. 3 shows an example of the networking of high-voltage appliances of an electrostatic separator,

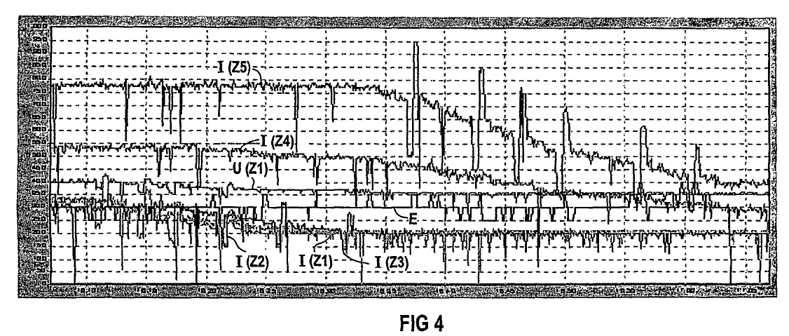

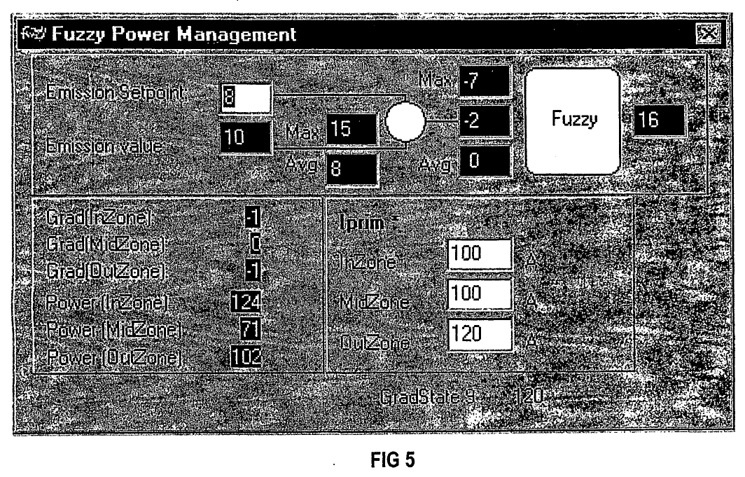

FIG. 4 shows regulation of the particle emission and separator currents,

FIG. 5 shows a user interface for one embodiment of the method according to the invention.

FIG. 1 uses a diagram to show the basic profile of the dust particle emission as a function of the current level which is supplied to an electrostatic separator. The exhaust gas characteristics can be varied by variations in the production process, so that the curve shown in the example changes quantitatively.

In FIG. 2, 1 denotes a six-stage actual electrostatic separator which, according to the invention, is transformed to a separator model 2. The transformation is symbolized by a double arrow in FIG. 2. In the illustrated exemplary embodiment, the separator model 2 has an input zone 2a, a central zone 2b and an output zone 2c.

The input zone 2a, which corresponds to the stages 1a and 1b of the actual separator, has a high, inhomogeneous dust concentration in the exhaust gas. Charging as many of the particles as possible has an advantageous effect on the effectiveness of the central zone 2b and of the output zone 2c.

In the central zone 2b, which is formed from the stages 1c and 1d of the actual separator 1, the dust concentration is considerably

lower (approximately 1/20). In rare cases, a back corona can occur in the central zone 2b. The expression back corona means the end of the linear voltage rise despite the current level increasing.

In the output zone 2c, which is formed from the stages 1e and 1f of the actual separator 1, there are a large proportion of fine dust particles. Back coronas occur more frequently owing to the high-resistance dust coating on the plates. The initial value reacts in a sensitive manner to plate knocking.

After modifications in operation, for example by changing the current supply, in a zone, all the subsequent zones must be readapted.

At least one of the following parameters is taken into account for transformation of the actual electrostatic separator to a separator model:

actual value and nominal value of the separator current,

actual values, minimum values, maximum values and mean values of the separator voltage,

electrical power

operating mode (continuous operation or pulsed operation) and/or

if pulsed operation is active—at least one pulse pattern.

Parallel model zones in the gas flow are initially supplied with identical nominal values. Weighting factors for the parallel model zones are determined during the fine optimization process. Linear interpolation of the parameters, in particular of the actual values, is used for serial model zones. Different weightings are conceivable for the individual model zones in this case as well.

The choice of the operating mode for the back transformation from the separator model 2 to the actual separator 1 depends on the calculated

intensity of the back corona in the corresponding model zone.

The gradients of the emission (or of the opacity) are formed via the electrical partial power for the three model zones 2a, 2b and 2c at the present operating point of the actual electrostatic separator 1. To do this, the electrical power must be varied slightly about the present operating point in all the zones successively. The gradients of the three model zones are a measure of the influence of one model zone on the particle emission when the electrical power is varied. The nominal power levels for the model zones 2a, 2b and 2c are now optimized such that all three gradients are of equal magnitude, and the desired emission level is achieved precisely. At this operating point, the electrostatic separator is operated with the minimum possible power, at which the specified or the desired emission level is just achieved.

The use of fuzzy logic has been proven for a specific search for the optimum operating point. The use of other methods, for example neural networks or conventional search algorithms, is likewise possible in this case. Fuzzy logic should be used by preference since it can be implemented quickly, the rules which are used are abstract and it results in the capability to transfer the results obtained from it to other actual electrostatic separators. A further advantage of the use of fuzzy logic is that asymmetric regulators can easily be implemented by varying the association functions of a signal. A rise in the emissions requires the system to react in a rapid strong manner owing to the risk of limit values being exceeded while, in contrast, considerably more time is available when reducing the electrical power. The use of fuzzy logic thus improves the operational reliability.

In addition to the mean value of the particle emission, the peak values and the instantaneous values are also used as actual values. Consideration of the present values makes it possible to react

rapidly to rising values resulting from unpredictable process changes (for example soot production). Monitoring of the maximum prevents undesirable or impermissible emission peak values even during periodic or recurrent procedures (for example plate knocking).

In the exemplary embodiment illustrated in FIG. 3, the high-voltage supplies for the electrostatic separator are networked, with an optical Profibus 5 being chosen as the transmission system. The high-voltage supply 3 as well as the high-voltage supplies 41, 42, 43, 44 and 45 are thus connected to one another via the optical Profibus 5, via their monitoring devices 3K as well as 41K, 42K, 43K, 44K and 45K. Energy management is carried out by a personal computer 6 which, in the illustrated exemplary embodiment, is operated using the Windows NT operating system. It is also possible to use an automation system, for example Simatic S7, for the purposes of the invention.

The individual high-voltage supplies contain a set of parameters which is activated when data communication is lost. Operation at the rated current, for example, may be stored here. If the emission values are exceeded by a value which can be predetermined, this results in a current increase in all the high-voltage supplies irrespective of the optimization at that time. In a second stage, the rated current can be activated in all the high-voltage supplies if the particle emission rises further.

FIG. 4 shows the particle emission E remaining constant as well as the regulation of the separator currents I(Z1) to I(Z5) in the zones Z1 to Z5 to lower values while the boiler is being shut down. U(Z1) denotes the voltage profile in the zone Z1. The times at which the gradients are determined can be seen from the brief current changes in both directions.

FIG. 5 shows the user-friendly user interface of the software which is used on the personal computer 6.

1. A method for operating an electrostatic separator, in which the actual electrostatic separator (1) is transformed to a separator model (2) which has at least one input zone (2a), at least one central zone (2b) and at least one output zone (2c), with each of the at least three model zones (2a-2c) having an associated characteristic which can be predetermined, using which the power supply for a number, which can be predetermined, of these model zones (2a-2c) is regulated as a function of the nominal value for the particle emission (E).

2. The method as claimed in claim 1, with at least one of the following parameters being taken into account for the transformation of the actual electrostatic separator (1) to a separator model (2):
actual values and nominal values of the separator currents,
actual values, minimum values, maximum values and mean values of the separator voltage,
electrical power
operating mode (continuous operation or pulsed operation) and
if the electrostatic separator is operated in the pulsed mode—at least one pulse pattern.

3. The method as claimed in claim 2, with parallel zones in the exhaust gas flow initially being supplied with identical nominal values.

4. The method as claimed in claim 2 or 3, with weighting factors being determined by means of fine optimization for the parallel model zones in the exhaust gas flow.

5. The method as claimed in one of claims 2 to 4, with linear interpolation of the parameters, in particular of the actual values, being used for serial zones.

6. The method as claimed in claim 5, with weighting factors being determined by means of fine optimization for the serial model zones in the exhaust gas flow.

7. The method as claimed in one of claims 1 to 6, with the optimum operating point of the actual electrostatic separator being determined using fuzzy logic.

8. The method as claimed in one of claims 1 to 6, with the optimum operating point of the actual electrostatic separator being determined using a neural network.

9. The method as claimed in one of claims 1 to 6, with the optimum operating point of the actual electrostatic separator being determined using conventional search algorithms.
